(19) United States
(12) Patent Application Publication
(10) Pub. No.: US 2009/0187441 A1
(43) Pub. Date: Jul. 23, 2009

(54) System and Method for Vendor Management

(75) Inventors: Peter Richardson, Ottawa (CA); Vincent Verrault, Ottawa (CA); Camil Kourany, Greely (CA); Vinayak Darshan, Ottawa (CA)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: IM-ONTRACK INC., Ottawa (CA)

(21) Appl. No.: 12/017,847

(22) Filed: Jan. 22, 2008

(51) Int. Cl. G06Q 10/00

(52) U.S. Cl. 705/7

(57) ABSTRACT

A system and method are provided for vendor management during a procurement process. Vendor qualification data is stored and compared relative to a procurement request. Based upon statistical data in relation to previous bidding information and vendor relevance a list of recommended Vendors for invitation can be generated. The recommended list ensures fairness in the selection of Vendors and statistics are automatically updated. Data in relation to the selection process is maintained to provide an audit trail through the procurement process.

### TECHNICAL FIELD

The present invention relates to vendor management and in particular to managing vendor invitation and selection during a purchasing or contracting process.

### BACKGROUND

In process of purchasing trade services, products or professional services a Buyer typically invites multiple Vendors to bid on a job to supply a service or items. In the alternative a sole source Vendor may be selected based upon job requirements. In either case, there are two main considerations that concern the purchaser. The considerations are that Vendor(s) should be selected fairly without favouritism and if they are to select the Vendor(s) in a perceptibly unfair manner, the Buyer must be armed with enough relevant information justify their decision. Traditional vendor management systems provide little tracking ability in the decision making process involved in the selection of vendors. The process of determining vendors that are qualified and relevant to take part in a tender or bidding process, in addition to actually inviting vendors to be involved, up to the final vendor selection, can occur with little control or traceability. Although at the time of awarding the contract all efforts may have been made to conduct the process in a fair and equitable manner, these decisions may come into question in future years and the information to justify the decision may not be available. The ability to provide a clear record of the process in addition to justifying the process fairness is highly desirable to removing any doubt in regards to overall process.

### SUMMARY OF THE INVENTION

The disclosure provides a system and method for vendor management during a procurement process. Vendor qualification data is stored and compared relative to a procurement request. Based upon statistical data in relation to previous bidding information and vendor relevance a list of recommended Vendors for invitation can be generated. The recommended list ensures fairness in the selection of Vendors and statistics are automatically updated. Data in relation to the selection process is maintained to provide an audit trail through the procurement process.

Thus, an aspect provides a system for providing vendor management during a procurement process to ensure fairness in the procurement process, the system comprising: a memory; a processor for executing the steps of: determining vendor qualification; generating procurement requests; and processing procurement responses.

A further aspect provides a method of a method for providing vendor management during a procurement process to ensure fairness in the procurement process, the method comprising the steps of: determining vendor qualifications; generating procurement requests; and processing procurement responses.

Yet a further aspect provides a computer readable medium containing instructions for providing vendor management during a procurement process to ensure fairness in the procurement process, the instruction which when executed on a processor perform the steps of: determining vendor qualifications; generating procurement requests; and processing procurement responses.

Other aspects and features will become apparent to those ordinarily skilled in the art upon review of the following description of specific embodiment of the invention in conjunction with the accompanying figures.

### BRIEF DESCRIPTION OF THE DRAWINGS

Further features and advantages of the present invention will become apparent from the following detailed description, taken in combination with the appended drawings, in which:

FIG. 1 is a schematic representation of vendor management process;

FIG. 2 is a messaging flow of a vendor management process;

FIG. 3 is a flow diagram for providing vendor management;

FIG. 4 is a flow diagram for providing vendor qualification;

FIG. 5 is a flow diagram for providing procurement requests;

FIG. 6 is a flow diagram for providing procurement responses;

FIG. 7 is a system diagram of a vendor management system;

FIG. 8 is a representation of Type of Work, Area of Work and Value of Work parameter records;

FIG. 9 is a representation of a Vendor Qualification record;

FIG. 10 is a representation of a Vendor record;

FIG. 11 is a representation of a Vendor Selection Helper record;

FIG. 12 is a representation of a Procurement Request record; and

FIG. 13 is a representation of a Procurement Response record.

It will be noted that throughout the appended drawings, like features are identified by like reference numerals.

### DETAILED DESCRIPTION

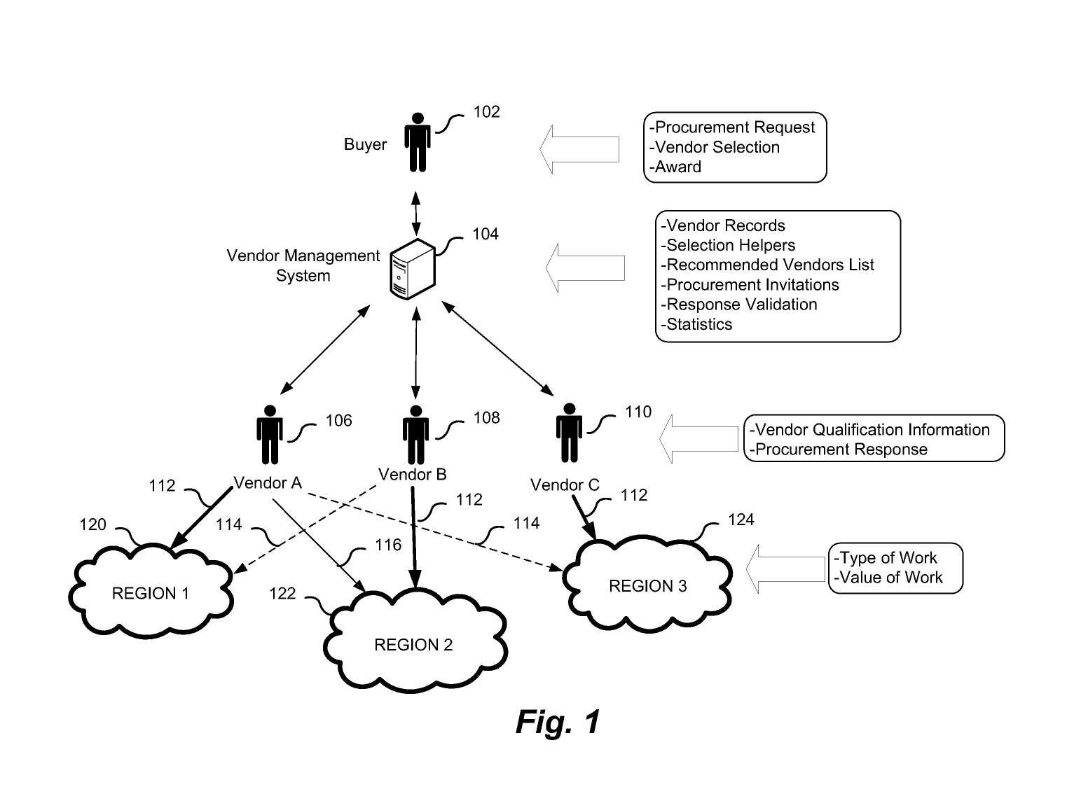

Embodiments are described below, by way of example only, with reference to FIGS. 1-13. A system and method for vendor qualification and selection in a procurement process is provided. The ability to provide and an automated selection process and to track the invitation and selection processes are important in proving that fairness has occurred and remove any doubt of favouritism or unfair practices. The decision on who should be selected into the bidding process can be based upon collected information from previous bidding process which enables fair selection of vendors that should be invited to bid in the procurement process. The process may be defined for any number of work items, goods or services. For example within the construction industry specific work items defining trades may be used within the procurement process. The purchasing of goods available from multiple vendors may also be managed by the process and likewise legal or technical services may also be managed by the process to ensure fairness.

FIG. 1 shows a schematic representation of vendor management process. A Buyer 102 defines a procurement request, be it for goods or services, which is provided to the Vendor Management System 104 electronically. The Vendor Management System 104 facilitates the procurement process between the Buyer 102 and Vendors 105, 108 and 110. Each of the Vendors 106, 108 and 110 may located or service one or more geographic regions. For example Vendor 106 may work or provide service in a Primary Region (lines 112); Secondary Regions with branch office (lines 116), and; Secondary Regions with no branch office (lines 114). In each of the regions a vendor may offer different product or services. The qualification information defining the operational regions from each of the Vendors is provided to the Vendor Management System 104. The Vendor Management System maintains Vendor Records for each Vendor relative to the regions they service and the value of the work, products or services that they provide (when the term work is referred to in the remaining description it is assumed that products or services may be similarly identified). The Vendor Management System 104 maintains Selection Helpers which track detailed statistical information on each Vendor in relation to previous procurement processes.

To ensure fairness in the procurement process, based upon the Procurement Request, a list of eligible Vendors is generated by the Vendor Management System 104 and provided to the Buyer 102. Based upon the defined purchasing process the Vendor Management System 104 can provide a predefined number of Vendors that meet the procurement request parameters such as type of work, price of work, and volume in the case of goods. Depending on the work, product or service additional fields can be provided to further define the procurement request such as deliver time frames. In addition the list of recommend vendors is generated based up the statistical information in relation to the previous invitation statistics and possibly performance of the vendors. Once the Buyer 102 has either approved the selection or made changes to the list of eligible and relevant Vendors to which a invitation to bid has been made, the Vendor Management System 104 can log the list of bidders and any changes to the selection and send invitations to the Vendors to bid on the work. The selected Vendors can then provide a procurement response to the Vendor Management System detailing their proposed work. The Vendor Management System 104 can validate the Procurement Response to ensure that all the criteria of the procurement request have been meet and the provide the list of qualified Vendors to the Buyer 102. Depending on the procurement structural criteria the Vendor Management System may potentially automatically award the winning Vendor or await approval from the Buyer of the winning Vendor.

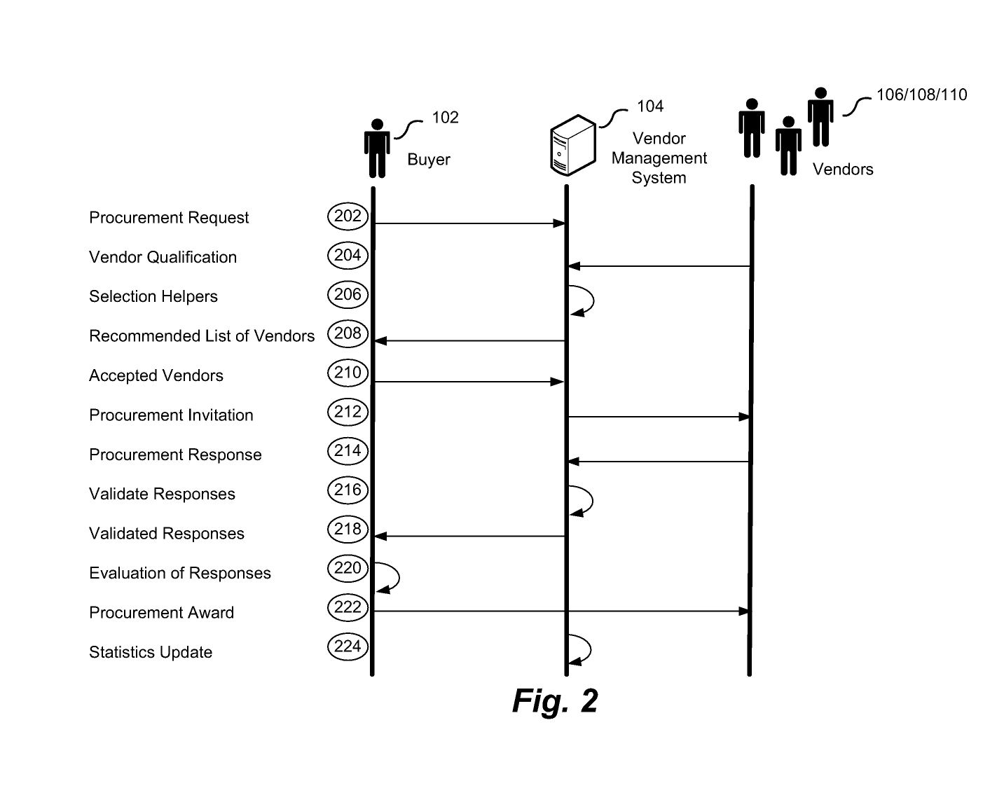

FIG. 2 is a messaging flow of an embodiment of a vendor management process. Procurement request at step 202 is made form the Buyer 102 to the Vendor Management System 104. Vendors 106, 108 and 110 provide qualification information to the Vendor Management System 104. The qualification information may be provided based upon the procurement request requirements or at any time in the process to qualify vendors at step 204. The Vendor Management System 104 generates selection helpers at step 206 which match the vendor qualifications with future procurement requests. The recommended list of vendors that best match the requests and are statistically most eligible for bidding are provided as part of a recommended list of vendors at step 208. The when the Buyer 102 accepts the vendors at step 210 they are provided to the Vendor Management System 104. The procurement invitations are issued at step 212 to the selected Vendors. Procurement responses are generated at step 214 by the selected Vendors. The responses can the be validated at step 216 by the Vendor Management System 104 to ensure that either selection rules are met and/or the requirement of the procurement request. The validated responses are then sent to the Buyer 102 at step 218. The purchaser can then evaluate the responses at step 220 and award the procurement to a particular Vendor at step 222. The Vendor Management System 104 can log the selection and any information in relation to the awarding of the contract. The Vendor Management System can then update statistics of the Vendors Selection Helpers at step 224 in relation to the invitations issued, responses and award information.

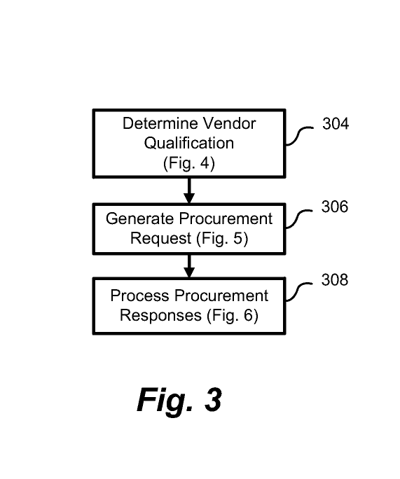

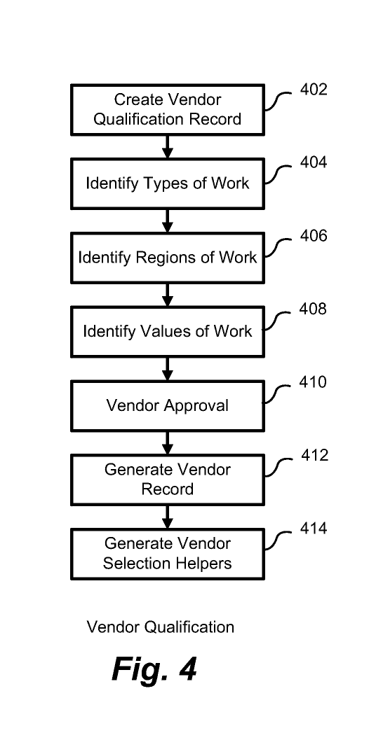

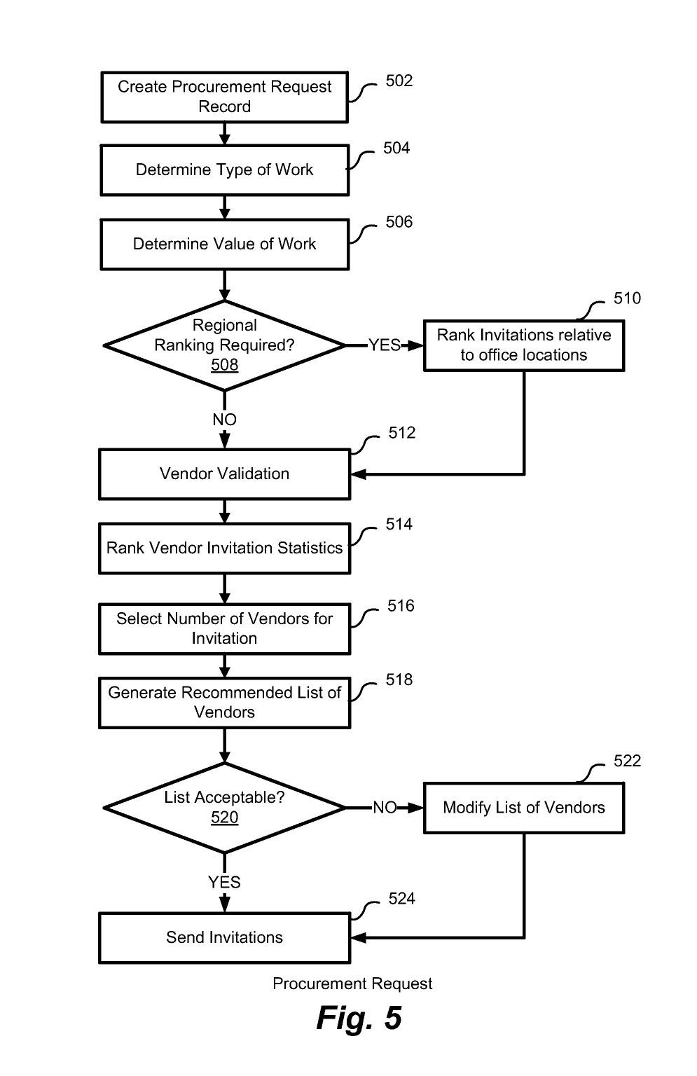

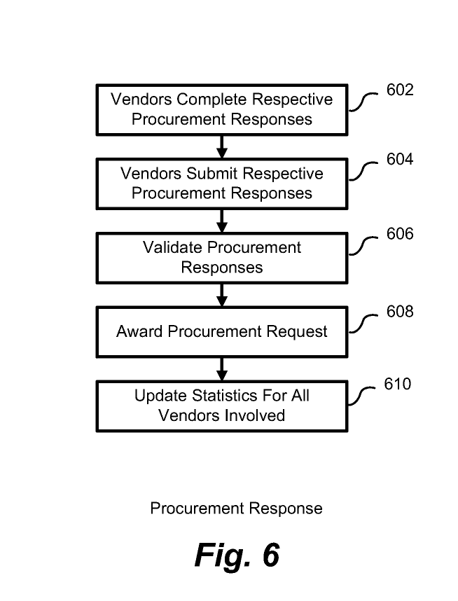

FIG. 3 is a flow diagram for providing vendor management. Vendor qualifications are determined at step 304 based upon information received from the Vendors and will be further discussed at in connection with FIG. 4. Procurement requests can then be sent to selected Vendors at step 306 and will be further discussed in connection with FIG. 5. The procurement responses are then processed and awarded at step 308 and will be further discussed in connection with FIG. 6.

FIG. 4 is a flow diagram for providing vendor qualification. A Vendor qualification record is generated at step 402 based upon information provided by Vendors regarding their capabilities. The process allows a Buyer to maintain a relevant and up to date list of Vendors that they know are currently qualified to perform the work that they need. A Vendor Record is created which stores the basic Vendor information as well their bid history and qualification status. The procurement process enables the automatic generation of a fair list of Vendors that are qualified to do the required work. The Vendor Qualification process allows for vetting and approval of a potential Vendor, as well as providing a means of storing historical records of their qualification(s).

Apart from the basic Vendor information such as Company Name, Address and Contacts, there are three key collections of information that need to be identified and captured to ensure that the system will be able to appropriately choose from the list of Vendors when a procurement need arises:
1) Type of Work—What kinds of work does the Vendor wish to perform at step 404
2) Regions of Work—In what geographical regions does the Vendor wish to perform the work at step 406
3) Value of Work—What is the value of work the Vendor wishes to perform at step 408

Once a Vendor has been approved at step 410 by meeting defined qualification criteria as set out by the Buyers to ensure suitability of the Vendors to potentially complete work. A Vendor Record is created at step 412 and becomes available for selection for procurement needs. The Vendor Selection Helpers are then generated at step 414. Type of Work and Value of Work must be taken into account when statistics are being captured for storage in or calculated from data stored within the Vendor Selection Helper. In fact, each combination of the three parameters will be considered as it's own silo of statistical information for a particular Vendor. Area of Work must be taken into consideration to ensure that the system will only find Vendors that perform work in which the procurement need has arisen.

For example, assume that there are:

1) Four types of work:
Division 03—Concrete
Division 04—Masonry
Division 05—Metals
Division 06—Wood, Plastics, and Composites

2) Three regions of work defined as Regions 1, 2 and 3;

3) Four value ranges of work defined as:
Small: $0-$25,000
Medium: $25,000-$200,000
Large: $200,000-$1,000,000
Very Large: $1,000,000-$10,000,000

Now let's consider Vendor A, which has chosen the following options:

| | Head | Branch | Also | |
|---|---|---|---|---|
| Type of Work | Office | Offices | Works In | Value of Work |
| Division 03 - Concrete | Region 1 | Region 2 | Region 3 | Small: $0-$25,000 |
| Division 04 - Masonry | | | | Medium: $25,000-$200,000 |

Vendor B has chosen the following options:

| | Head | Branch | Also | |
|---|---|---|---|---|
| Type of Work | Office | Offices | Works In | Value of Work |
| Division 03 - Concrete | Region 2 | | Region 1 | Medium: $25,000-$200,000 |
| | | | | Large: $200,000-$1,000,000 |

And Vendor C has chosen the following options:

| | Head | Branch | Also | |
|---|---|---|---|---|
| Type of Work | Office | Offices | Works In | Value of Work |
| Division 04 - Masonry | Region 3 | | | Small: $0-$25,000 |
| | | | | Medium: $25,000-$200,000 |
| | | | | Large: $200,000-$1,000,000 |

Now let's say a procurement need arises in Region 3 for Masonry work worth $500,000. It would not be relevant for the system to suggest Vendor A or Vendor B for the work since Vendor A can't handle a job that size, Vendor B doesn't do Masonry work. Nor should the system ‘count’ the event as a potential invitation for Vendor A and Vendor B since neither of them could have been considered in the first place.

Continuing with this example, say a procurement need arises in Region 1 for Concrete work worth $75,000. In this case the system should consider both Vendor A and Vendor B, and in fairness the one that should be at the top of the list is the one that has lowest invitation percentage for that type of work for that value.

By considering the specific combination of the parameters a Vendor that does more than one type of work, likely has different offices or crews for each type. If they get invited to a Concrete job, it shouldn't count against them if a Masonry job then comes along. Similarly, if a Vendor gets invited to a job in the Region 1, it shouldn't count against their Region 2 office if a job then comes along there. As we'll see later, a Vendor will be able to identify that the work in areas where they don't have offices, but the system will favour the Vendors that have offices in the job's area.

Lastly, if through the roster management, Vendor C gets invited to a small job, they wouldn't want that to count against them when a large job came along. However, as discussed later, if a Vendor is invited to a large job, it will count against their chances to get invited to smaller job.

To manage this, once a Vendor Qualification has been vetted and approved, a separate record, called a Vendor Selection Helper is created at step 414 and maintained by the system for each combination for the purposes of tracking statistical information. For example the Vendor Selection Helpers may be defined such as:

### Vendor A:

| Type of Work | Region of Work | Office in Region | Value of Work |
|---|---|---|---|
| Division 03 - Concrete | 1 | Y | Small: $0-$25,000 |
| Division 03 - Concrete | 1 | Y | Medium: $25,000-$200,000 |
| Division 03 - Concrete | 2 | Y | Small: $0-$25,000 |
| Division 03 - Concrete | 2 | Y | Medium: $25,000-$200,000 |
| Division 03 - Concrete | 3 | N | Small: $0-$25,000 |
| Division 03 - Concrete | 3 | N | Medium: $25,000-$200,000 |
| Division 04 - Masonry | 1 | Y | Small: $0-$25,000 |
| Division 04 - Masonry | 1 | Y | Medium: $25,000-$200,000 |
| Division 04 - Masonry | 2 | Y | Small: $0-$25,000 |
| Division 04 - Masonry | 2 | Y | Medium: $25,000-$200,000 |
| Division 04 - Masonry | 3 | N | Small: $0-$25,000 |
| Division 04 - Masonry | 3 | N | Medium: $25,000-$200,000 |

### Vendor B:

| Type of Work | Region of Work | Office in Region | Value of Work |
|---|---|---|---|
| Division 03 - Concrete | 1 | N | Medium: $25,000-$200,000 |
| Division 03 - Concrete | 1 | N | Large: $200,000-$1,000,000 |
| Division 03 - Concrete | 2 | Y | Medium: $25,000-$200,000 |
| Division 03 - Concrete | 2 | Y | Large: $200,000-$1,000,000 |

### Vendor C:

| Type of Work | Region of Work | Office in Region | Value of Work |
|---|---|---|---|
| Division 04 - Masonry | 3 | Y | Small: $0-$25,000 |
| Division 04 - Masonry | 3 | Y | Medium: $25,000-$200,000 |
| Division 04 - Masonry | 3 | Y | Large: $200,000-$1,000,000 |

Since Vendors will be competing against one another for a particular Type of Work, each type should be narrow enough to allow the Buyer to accurately find a Vendor that does the what the they're is looking for, but broad enough so that the statistics are relevant. For instance, it doesn't make sense to statistically distinguish between how many times Vendors have been invited to ‘26 09 23 Lighting Control Devices’ jobs to how many times they have been invited to ‘26 09 26 Lighting Control Panelboards’ jobs, but it does make sense to distinguish between how many times Vendors have been invited to ‘Division 26—Electrical’ jobs compared to ‘Division 22—Plumbing’ jobs.

Fortunately, in the construction industry a logical breakdown of Types of Work has already been defined by the Construction Specifications Institute: the MasterFormat 2004 Edition. A Vendor can be defined such that they do any Type of Work as it exists in the MasterFormat hierarchy, but the statistics will be tracked at the Division level. For instance, if a Vendor is invited to a ‘26 09 23 Lighting Control Devices,’ statistically it will be deemed to have been invited to a ‘Division 26—Electrical’ job. The division of the types of work might also be defined relative to other standards such as product types using product divisions or product characteristics based upon industry standard or user defined classifications. Similarly divisions may be created for services to define the type of service provided into sub-categories.

Each geographical region should be narrow enough to allow the Buyer to accurately find a Vendor that does work in the area, but broad enough so that the statistics are relevant. The boundaries should be defined such that within a given area, a typical Vendor will work within the entire area. Define the areas too small, however, and each Vendor will have a needlessly long list of Regions of Work. It should be understood that depending on the work, product or service required regional tracking may not be required and can overridden.

Invitation statistics are not tracked per Regions of Work. Rather, they can be tracked per Vendor record. This helps determine if a particular Vendor should actually be set up as more than one Vendor record. For instance, consider the following:

Vendor A
office in Region 1
branch office in Region 2
works in Region 3

Vendor B
office in Region 2
works in Region 1

Vendor C
office in Region 3

In this scenario, Vendor A should actually have two Vendor records created—Vendor A1 and Vendor A2, each with separate statistics being tracked.

When a job comes available in Region 2, both Vendor A and Vendor B should be considered equally based on the number of times that they have been invited to a job in Region 2. When a job comes available in Region 3, Vendor A and C should be considered, however, Vendor C should be considered solely based on the number of jobs that have come available in Region 3, whereas Vendor A should be considered based on the total number of jobs that have come available in Region 1 and Region 3 combined. This strategy automatically favours the Vendors that have offices in the Region of Work for the job.

Each Value of Work definition should be narrow enough to allow the Buyer to accurately find a Vendor that does the size of job they're considering, but broad enough so that the statistics are relevant. Often, putting values around the terms small, medium and large (and sometimes very large) is often a good way to adequately define the Values of Work.

A Vendor's invitations to bid are tracked based on the jobs' Value of Work. However, some additional filtering needs to be employed. As you would expect, if a Vendor is invited to a small job, that invitation should not considered when the next large job comes available. But if a Vendor is invited to a large job, that invitation should be considered when the next small job comes available. This filtering will favour the small companies in getting invited to the small jobs.

The Selection Helper can capture data for generating statistics such as:
Number of potential invitations to bid
Number of actual invitations to bid
Invitation percentage
Number of bids submitted
Number of invitations declined
Number of successful bids
Total value of all successful bids
Total value of next highest bids for all successful bids
Number of unsuccessful bids
Total value of all unsuccessful bids
Total value of winning bids for all unsuccessful bids
Number of times manually removed from the system recommended

### Vendor List

Number of times manually added to the system recommended

### Vendor List

Vendor performance rating

The Selection Helper may also provide bid statistics for the Vendor's most recent bid and its relation to other bids such as:
Date of last invitation
Date of last bid submitted
Date of last invitation declined
Date of last successful bid
Value of last successful bid
Value of next highest bid for last successful bid
Date of last unsuccessful bid
Value of last unsuccessful bid
Value of winning bid for last unsuccessful bid

In order for the system to fairly recommend a list of Vendors that the Buyer should invite to bid, there are two main pieces of information that it must consider: number of potential invitations and number of invitations to bid. Whenever there is a job for which an invitation is issued to one or more Vendors, the system will count it as a potential invitation for all Vendors where the following criteria is met:
The Vendor is currently qualified;
The Vendor performs the type of work requested;
The Vendor performs the work in the geographical area;
The Vendor performs the value of work requested.

Meanwhile, when a Vendor is actually invited to bid on a job, the system will count it as an invitation to bid.

Dividing the invitations to bid by the potential invitations will give an invitation percentage. By always recommending the Vendors with the lowest invitation percentage, no Vendors are unfairly invited more often than others. Even if a Buyer manually removes a recommended Vendor from the list, the system will continue to recommend that Vendor in an effort to even out the invitation percentages across all Vendors.

FIG. 5 is a flow diagram for providing procurement requests. The procurement record is created at step 502 based upon information provided by the Buyer in regards to work requirements. The type of work required is determined at step 504 based upon the Buyer's selection and the value of the work is determined at step 506. Depending on the product or service, regional ranking may be provided at step 508. For example if allocation of the work is to be fairly considered per region the Selection Helper record must be utilized to determine statistical relevance per region. If YES at STEP 508, ranking can be performed relative to regions where the vendors have an office, have a branch office or work/sell in the region from another office and how the representation of the office can impact vendor selection.

Consider a Vendor that has a Primary Region and one or more Secondary Regions. The Primary Region is the region in which their main office is actually situated. The Secondary Regions are other regions in which they are prepared to work. There are a few ways to look at this:

1. If a Vendor has record has branch office each one would be represented by a vendor record in addition to the vendor record representing the main office. The Vendor may also work in other regions in which they may not have office. In which case the secondary region can only be represented by one of their offices as selected by the Vendor. Invitation statistics are tracked by region of work, however vendors whose Primary Region matches the region in which the work is required will always be at the top of the list.

The implications of ranking this way is that companies may never work in other regions that they are prepared to travel to. For example assume two regions, Region 1 and the Region 2. Consider Company A in Region 1 that is prepared to travel to the Region 2 to do work, but they don't have an office there. Assuming there are plenty of companies that do have offices in the Region 2, the Company A may never get invited. They'll likely only be invited to work in Region 1. The flip side, though, is if there aren't enough companies with a regional presence in Region 1, as much as the local companies are favoured, the non-local companies can fill out the roster in the invitation process.

2. In the Secondary Regions they may or may not have offices. In this case, if a ‘Company’ has more than one office, it still must be represented by only one Vendor Record. The invitation statistics are tracked by region of work.

The implications of ranking this way is smaller companies in less active regions will likely not get a fair chance at the work as a whole. For example, assume two regions, Region 1 and the Region 2. Consider Company A that only works in Region 1 and Company B that works Region 2 and Region 1. Company B will likely have a chance at lots of work in Region 2, but the moment a job finally becomes available in Region 1, they are on equal footing with Company A.

3. Regions aren't considered during the selection process except to ensure that a vendor actually works in the region in which the work is required. In this case invitation statistics are tracked by Vendor.

The implications of ranking this way is Vendors who work in active regions may not get invited to less active regions. For example, assume two regions, Region 1 and the Region 2. Consider Company A that only works in Region 1 and Company B that works Region 2 and Region 1, where Region 2 is very active and Region 1 is relatively less so. Company B will likely have a chance at lots of work in the Region 2, but the moment a job finally becomes available in Region 1, since Company A's invitation statistics are low they will be heavily favoured over Company B.

If ranking is not required, NO at step 508, or regional ranking has been completed at step 510, the vendor validation is performed at step 512 to ensure that a vendor is still qualified. This can be performed by a vendor rating stemming from post project surveys or may simply be validation that the Vendor is still qualified to be part of the process. If a Vendor rating drops below a certain value, they are automatically disqualified. Higher ratings shouldn't mean they are higher on the list.

The Vendors can then be ranked based upon invitation statistics at step 514 generated relative to the data contained by the Vendor Selection Helpers. A defined number of Vendors for being part of the invitation process can then be selected at step 516. The number of Vendors can be selected by a predefined number or user selected number. The list of recommended vendors is selected at step 518. The list can then be verified for acceptability at step 520 either by the Vendor Management System or the Buyer. If the list is not accepted it can be modified at step 522 by the Buyer. Any modifications to the list are logged in order to ensure traceability. Once the list is accepted, YES at 520, the invitations for bidding are sent to the Vendors at step 524.

FIG. 6 is a flow diagram for providing procurement responses process. Vendors complete their respective procurement responses providing detailed information in regards to the procurement request at step 602. The responses are submitted at step 604. The responses are validated at step 606 by the Vendor Management System to ensure compliance with the procurement request and bidding process procedures. The validated response can be provided to the Buyer for final selection or may be selected by an automated process such as by lowest bidder or closet to average cost methodologies. Once the winner has been selected the procurement is awarded at step 608. Statistics for all the Vendors involved can then be updated to reflect the new invitation statistics.

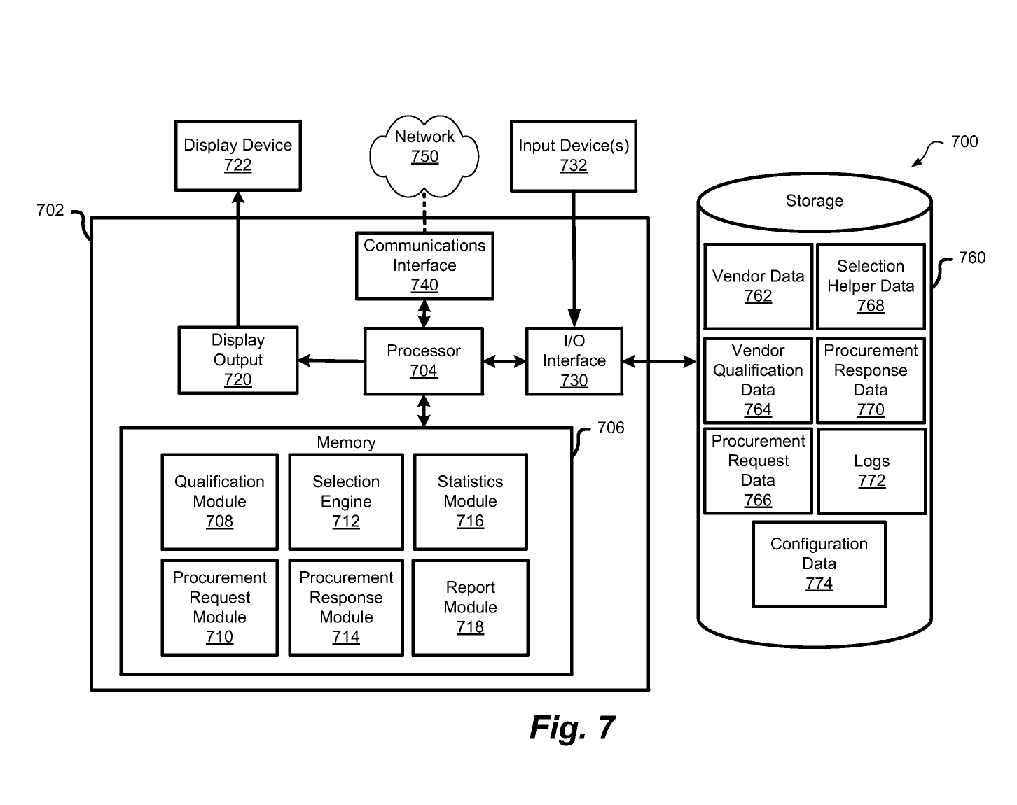

FIG. 7 is a system diagram of a vendor management system 700. The Vendor Management System 700 a computing device 702 for retrieving, storing and processing data. The Vendor Management System 700 may be implemented as computer software in the form of computer readable code executed. The computing device 702 comprises central processing unit (CPU) 704 and memory 706. The CPU may be a single processor or multiprocessor system. In various computing environments, main memory 706 and storage 760 can reside wholly in a computer environment, or they may be distributed between multiple computers.

The computer processor 704 or similar device may be programmed in the manner of method steps, or may be executed by an electronic system which is provided with means for executing these steps. The storage device 760 communicates with processor 704 through and Input/Output interface 730. The storage device 760 includes a databases for storing data relevant to the vendor management process. For example, Vendor data 762, Vendor Qualification data 764, Procurement Request data 766, Selection Helper data 768, Procurement Response data 770, Logs 772 for recording transactions with databases and Configuration data 774 for defining system preferences. The databases may be maintained independently or be part of a single database structure. The storage may include both fixed and removable media, such as magnetic, optical or magnetic optical storage systems, Random Access Memory (RAM), Read Only Memory (ROM) or any other available mass storage technology. The I/O interface 730 may also provide access to input devices 732, which may include and not be limited to keyboard or mice input. A display output 720 can be provided by a video graphics card providing video output to a display device 722. Collection of data from Buyers and Vendors may be provided through a web interface or through standard document formats. The server may include a web-site or web page generation module in standard formats such as HTML or XML for providing a graphical user interface for entering and accessing data. A communications interface 740 can provide access to communications networks 750, such as for example the Internet, enabling automation of the procurement process between the Buyer and Vendors if required. Procurement requests and responses can be submitted electronically with the Vendor Management System providing gatekeeper functionality in the process to ensure fairness and traceability.

The memory 706 can contain instructions for executing the Vendor Management System which may be sub-divided into one or more processing modules. The module may comprise a Qualification module 708 for creating vendor records in the vendor database 762 and vendor qualification records in the vendor qualification database 764. Procurement Request module 710 for processing the procurement request from the Buyer and storing the relevant information in the Procurement Request Database 766. A Selection engine 712 for providing the list of recommended vendors by utilizing the Selection Helpers from the Selection Helper database 768. The Procurement Request module 710 can then generate bid invitation for each of the selected Vendors. A Procurement Response module 714 then processes the received Vendor responses and stores the received responses in the Procurement Response database 770. The responses are validated to ensure that they meet the bid requirements can then be automatically selected by the Vendor Management System or provided to the Buyer for final selection. A Statistics module 716 can then update the statistics data stored in the Vendor Selection Helpers based upon the completion of the bidding process. A Report module 718 can then be accessed to generate reports related to the bidding process or provide audit information retrieved from the Log database 772. Vendor system configuration data 774 provides information relevant to configure the Vendor Management system defining available parameters for record creation.

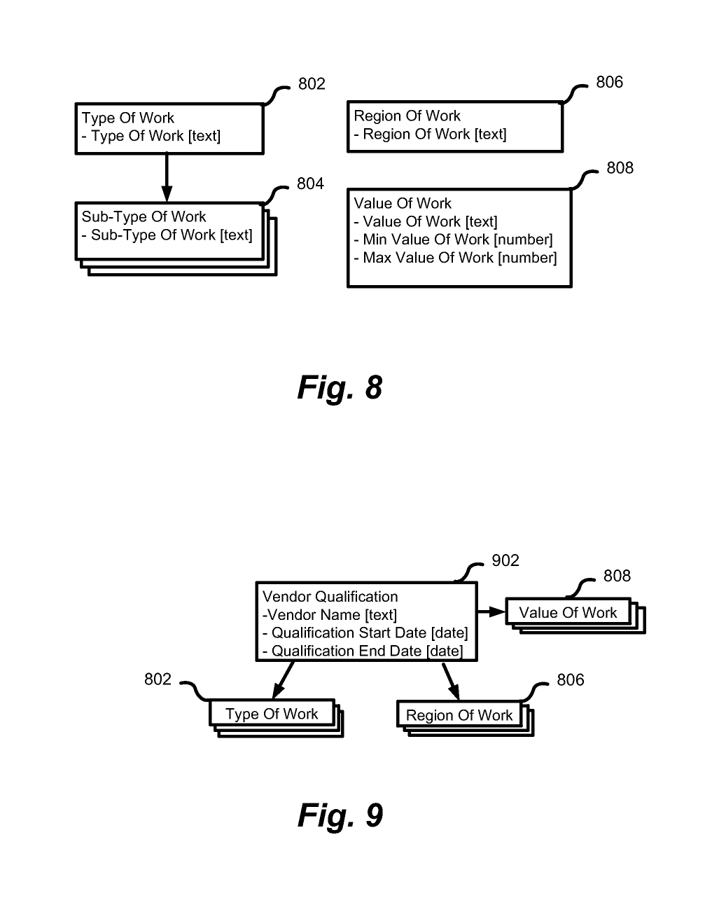

FIG. 8 is a representation of Type of Work record 802 which can be stored as configuration data 774 which defines the default parameters available for use with other records. The Type of Work record can contain multiple Sub-Types of Work records 804 defining types or work, goods or services available within the system. Region of Work record 806 defining the selectable regions in which the Vendors may work which can be stored as configuration data 774. Value of Work record 808 defining the ranges for values of the work or product.

FIG. 9 is a representation of a Vendor Qualification record 902 which is associated with a particular vendor name and can be stored as Vendor Qualification data 764. Each Qualification record 902 can contain a qualification start data and a qualification end date and can contain multiple Type of Work records 802, Region of Work records 806 and Value of Work records 808.

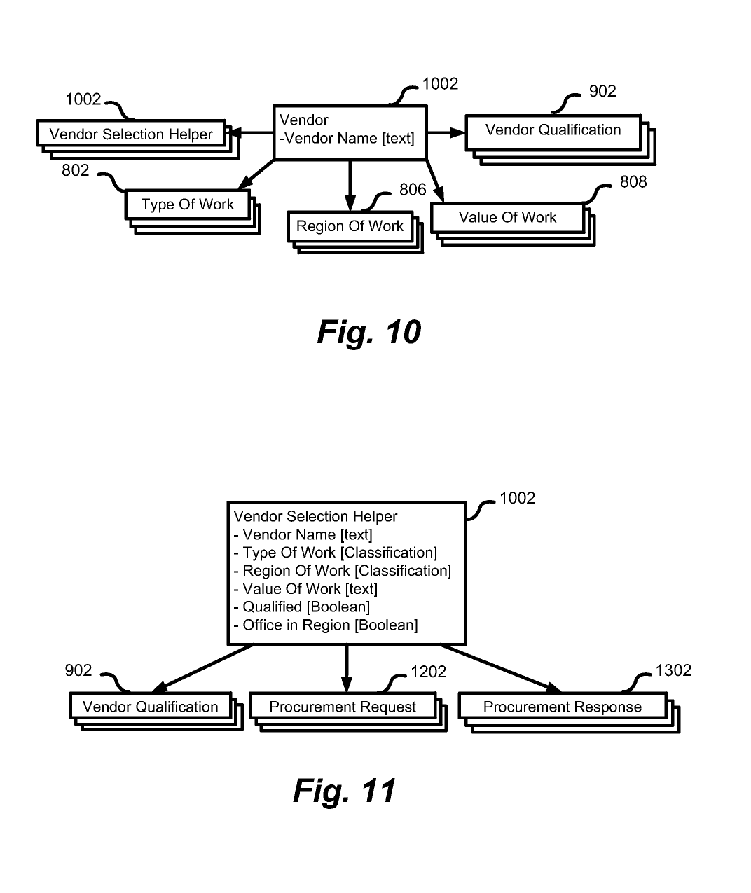

FIG. 10 is a representation of a Vendor record 1002 associated with a particular vendor and can be stored as Vendor data 762 and contain multiple Vendor Selection Helper records 1002, Type of Work records 802, Region of Work records 806, Value of Work records 808 and Vendor Qualification records 902.

FIG. 11 is a representation of a Vendor Selection Helper record 1002 provides the Vendor Name, Type of Work classification, Region of Work classification, Value of Work and Qualification status identifier and can be stored as Vendor Selection Helper data 768. Each Vendor Selection Helper 1002 is associated with multiple Vendor Qualification records 902, Procurement Request records 1202 and Procurement Response records 1302.

The Vendor Selection Helper helps provide information for generating statistics by queries defined by:

Procurement Request. Type Of Work=Vendor Selection Helper. Type Of Work

Procurement Request. Value Of Work=Vendor Selection Helper. Value Of Work

Procurement Request.Closing Date And Time ‘in’ Qualification Period

There will also be a query to Procurement Response where:

Procurement Response.Vendor Name=Vendor Selection Helper.Vendor Name

Procurement Response.Type Of Work=Vendor Selection Helper.Type Of Work

Procurement Response.Value Of Work=Vendor Selection Helper. Value Of Work

Number of potential invitations to bid:

Potential Invitations=Σ_{count} [Procurement Request]

Number of actual invitations to bid:

Actual Invitations=Σ_{count} [Procurement Response]

Invitation Percentage:

Invitation Percentage=Actual Invitations÷Potential Invitations

Number of bids submitted:

Responses Submitted=Σ_{count} [Procurement Response], where:

Procurement Response. Submitted=TRUE

Procurement Response.Closing Date And Time<TODAY

Number of invitations declined:

Responses Declined=Σ_{count} [Procurement Response], where:

Procurement Response.Submitted=FALSE

Procurement Response.Closing Date And Time<TODAY Number of successful bids:

Responses Successful=Σ_{count} [Procurement Response], where:

Procurement Response.Submitted=TRUE

Procurement Response.Successful=TRUE

Procurement Response.Closing Date And Time<TODAY

Total value of all successful bids:

Successful Value Total=Σ_{Value} [Procurement Response], where:

Procurement Response.Submitted=TRUE

Procurement Response.Successful=TRUE

Procurement Response.Closing Date And Time<TODAY

Total value of next highest bids for all successful bids:

Next Highest Value Total=Σ_{NextHighestValue} [Procurement Response], where:

Procurement Response.Submitted=TRUE

Procurement Response.Successful=TRUE

Procurement Response.Closing Date And Time<TODAY Number of unsuccessful bids:

Responses Unsuccessful=Σ_{count} [Procurement Response], where:

Procurement Response.Submitted=TRUE

Procurement Response.Successful=FALSE

Procurement Response.Closing Date And Time<TODAY

Total value of all unsuccessful bids:

Unsuccessful Value Total=Σ_{Value} [Procurement Response], where:

Procurement Response.Submitted=TRUE

Procurement Response.Successful=FALSE

Procurement Response.Closing Date And Time<TODAY Total value of winning bids for all unsuccessful bids:

WinningValueTotal=Σ_{WinningValue} [Procurement Response], where:

Procurement Response.Submitted=TRUE

Procurement Response.Successful=FALSE

Procurement Response.Closing Date And Time<TODAY

Number of times manually removed from the system recommended

Vendor list:

Manually Removed=Σ_{count} [Procurement Response], where:

Procurement Response.Selection Type=‘Removed’

Number of times manually added to the system recommended Vendor list:

ManuallyAdded=Σ_{count} [Procurement Response], where:

Procurement Response.Selection Type=‘Added’

The Vendor Selection Helper may contain the data for generating the statistical data but may also contain the statistical data itself.

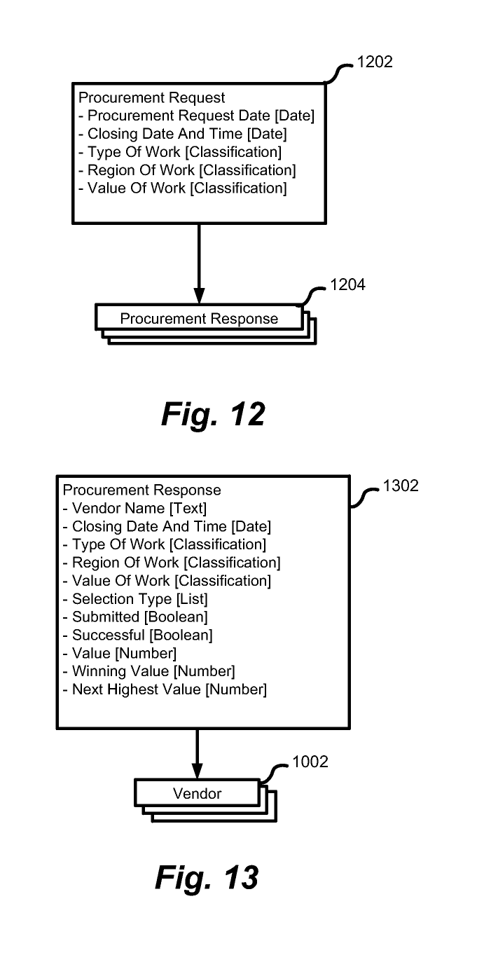

FIG. 12 is a representation of a Procurement Request record 1202 providing Procurement Request Date, Closing Date and Time, Type of Work classification, Region of Work classification and Value of Work classification and can be stored as Procurement Request data 766. The Procurement Request record 1202 can contain multiple Procurement Response records 1204.

FIG. 13 is a representation of a Procurement Response record 1302 providing Vendor Name, Closing Date And Time, Type Of Work classification, Region Of Work classification, Value Of Work Classification, Selection Type list, Submitted response identifier, Successful response identifier, Work value, Winning Bid Value and Next Highest Bid Value and can be stored as Procurement Response data 770. Each Procurement Response record 1302 can be associated with multiple Vendors 1002.

### Unfair Vendor Selection

A Buyer may wish to override the system's recommended list of Vendors. By tracking several other pieces of bid history information, the Buyer can make an informed decision based on data that they can point to in the case of an audit. For instance, they may decided to remove a Vendor from the list if it is apparent that the Vendor has continually failed to accept an invitation, or perhaps a Vendor continually provides a bid that is far more expensive than the other Vendors. By having that information readily available, the Buyer can easily and confidently make their decision with the supporting information required if they are ever called upon to explain their decision.

It will be apparent to persons skilled in the art that a number of variations and modifications can be made without departing from the scope of the invention as defined in the claims.

The method steps may be embodied in sets of executable machine code stored in a variety of formats such as object code or source code. Such code is described generically herein as programming code, or a computer program for simplification. Clearly, the executable machine code or portions of the code may be integrated with the code of other programs, implemented as subroutines, plug-ins, add-ons, software agents, by external program calls, in firmware or by other techniques as known in the art.

The embodiments may be executed by a computer processor or similar device programmed in the manner of method steps, or may be executed by an electronic system which is provided with means for executing these steps. Similarly, an electronic memory medium such computer diskettes, Digital Versatile Disc (DVD), Compact Disc (CD), Random Access Memory (RAM), Read Only Memory (ROM) or similar computer software storage media known in the art, may be programmed to execute such method steps. As well, electronic signals representing these method steps may also be transmitted via a communication network.

The embodiments described above are intended to be illustrative only. The scope of the invention is therefore intended to be limited solely by the scope of the appended claims.

We claim the following:

1. A system for providing vendor management during a procurement process to ensure fairness in the procurement process, the system comprising:
a memory;
a processor for executing the steps of:
determining vendor qualification;
generating procurement requests; and
processing procurement responses.

2. The system of claim 1 further comprising a storage medium wherein a procurement database resides.

3. The system of claim 2 where in the procurement database further comprises:
vendor data;
vendor qualification data;
procurement request data;
selection helper data;
procurement response data; and
configuration data.

4. The system of claim 3 where in the step of determining vendor qualification further comprises:
identifying types of work;
identifying regions of work; and
identifying values of work.

5. The system of claim 1 wherein the step of generating procurement requests further comprises generating a list of recommended vendors for providing an invitation to bid on the procurement request, wherein the list of recommended vendors is statistically determined based upon vendor qualifications and past procurement request data.

6. The method of claim 5 wherein the step of processing procurement responses further comprises updating statistical information for each of the vendors identified in a vendor database in relation to invitation statistics.

7. A method for providing vendor management during a procurement process to ensure fairness in the procurement process, the method comprising the steps of:
determining vendor qualifications;
generating procurement requests; and
processing procurement responses.

8. The method of claim 7 wherein the step of generating the procurement request further comprises receiving, from a Buyer, the procurement request defining the requirements of a job.

9. The method of claim 8 wherein the step of generating procurement requests further comprises generating a list of recommended vendors for providing an invitation to bid on the procurement request, wherein the list of recommended vendors is statistically determined based upon vendor qualifications and past procurement request data.

10. The method of claim 9 wherein the step of processing procurement responses further comprises updating statistical information for each of the vendors identified in a vendor database in relation to invitation statistics.

11. The method of claim 7 wherein the step of determining vendor qualification further comprises the steps of:
identifying types of work;
identifying regions of work; and
identifying values of work.

12. The method of claim 11 wherein the step of determining vendor qualification further comprises the step of:
approving vendor qualifications.

13. The method of claim 12 wherein the step of determining vendor qualification further comprises the steps of:
generating vendor record; and
generating vendor selection helpers.

14. The method of claim 13 wherein the step of processing the procurement request further comprises the steps of:
creating a procurement request record;
determining type of work related to the procurement request; and
determining a value of work related to the procurement request.

15. The method of claim 7 wherein the step of processing the procurement request further comprises the steps of:
providing regional ranking by statistical analysis of invitation statistics wherein invitations relative to other regions are included in statistical calculations.

16. A computer readable medium containing instructions for providing vendor management during a procurement process to ensure fairness in the procurement process, the instruction which when executed on a processor perform the steps of:
determining vendor qualifications;
generating procurement requests; and
processing procurement responses.
